(19) United States
(12) Patent Application Publication
(10) Pub. No.: US 2016/0016731 A1
(43) Pub. Date: Jan. 21, 2016

(54) LOADING DESIRED CONTAINER SEQUENCE ONTO BOARD OF CONTAINER CARRIAGE IN STORAGE SYSTEM

(71) Applicant: Sergey N. RAZUMOV, Moscow (RU)

(72) Inventor: Sergey N. RAZUMOV, Moscow (RU)

(21) Appl. No.: 14/333,199

(22) Filed: Jul. 16, 2014

(51) Int. Cl. B65G 1/04

(52) U.S. Cl. CPC B65G 1/0492

(57) ABSTRACT

A storage system having at least first, second and third storage sections, each configured for storing containers in multiple storage cells arranged in multiple rows at various horizontal levels with respect to ground. Storage cells in each row are arranged in multiple parallel lines extending in a first horizontal direction. Container carriages are moved in the first horizontal direction along parallel paths corresponding to the lines of the storage cells. The container carriage having a frame and a board for carrying containers is configured to position the board at different horizontal levels with respect to the frame. The container carriage is enabled to load containers onto its board in a desired sequence by taking a selected container from a storage cell in one row of the storage section when the board is positioned at one horizontal level, and placing the selected container to a storage sell in another row when the board is positioned at another horizontal level.

### TECHNICAL FIELD

This disclosure relates to retail logistics, and more particularly, to a storage system configured to enable a container carriage to load a desired sequence of containers onto its board.

### BACKGROUND ART

Order picking operations involve extracting specified goods from a storage area in a retail facility, and collecting them to prepare a customer's order. Order picking processes have become the most labor-intensive and costly part of the supply chain for any retail environment.

During an order picking process, there is a need for providing containers to a human picking operator or a picking device in a predetermined sequence so as to enable the operator or picking device to sequentially pick items required to fulfill orders. For instance, to fulfill the first order, items stored in a first group of containers may be required, to fulfill the second order, items from a second group of containers may be needed, and to fulfill the third order, items from a third group of containers should be delivered. In this case, it would be desirable to provide a picker with a sequence of containers in which the second group of containers follows the first group containers, and the third group follows the second group.

Also, an order may include multiple products that should be packed in a specific sequence. For example, heavy products need to be placed at the bottom of the container, while lightweight products may be placed after the heavy products. In this case, to efficiently fulfill the order, it would be desirable for each order to provide a picker with containers with the heavy products before containers with the lightweight products.

Further, it would be convenient to provide a picker with containers in a predefined sequence so as to enable the picker to place some items of an order separately from other items. For example, frozen products have to be placed separately from fresh products, food items need to be placed separately from chemical items, etc.

As disclosed in my copending patent application No. 14/299,527 filed on Jun. 9, 2014, entitled “ORDER PICKING STATION AND METHOD OF ORDER PICKING,” and incorporated herewith by reference, container carriages may be used to deliver containers to an order picking station configured to provide a picker with a predetermined sequence of containers.

To provide a predetermined sequence of containers to a picker in an efficient manner, it would be desirable to configure a storage system so as to enable each container carriage to load containers on its board in a desired order.

Also, to increase efficiency of the order picking process and reduce the cost of order fulfilment, it would be desirable to enable each container carriage to load a container sequence on its own, without assistance of a loading mechanism.

### SUMMARY OF THE DISCLOSURE

In accordance with one aspect, the present disclosure offers a storage system having multiple storage sections, each configured for storing containers in multiple storage cells arranged in multiple rows at various horizontal levels with respect to ground. The storage cells in each row are arranged in multiple parallel lines extending in a first horizontal direction. The storing sections are arranged so as to provide at least first and second passages between the storage sections.

A plurality of container carriages is configured for moving in the first horizontal direction along respective parallel paths corresponding to the lines of the storage cells. A container carriage having a frame and a board for carrying containers is configured to position the board at first, second and third horizontal levels with respect to the frame.

In particular, the container carriage is configured to move between the first and second passages under the storage cells arranged in a first row of the storage sections when the board is positioned at the first horizontal level. The first row may be the lowest row of storage cells.

Further, the container carriage is configured for loading containers onto the board in a desired sequence by taking a selected container from a storage cell in a second row of the storage section when the board is positioned at the third horizontal level, and placing the selected container to a storage sell in the first row when the board is positioned at the second horizontal level. A transition of the board between the second and third horizontal levels is provided when the container carriage is positioned in a passage between adjacent storage sections.

In accordance with one aspect of the disclosure, the container carriage may move along one or more first rails extending in a first horizontal direction. In addition, at least one lifting transportation device in each of the first and second passages may move along a pair of second rails extending along the passage in a second horizontal direction substantially perpendicular to the first horizontal direction so as to have access to the storage cells arranged in the storage sections from both sides from the passage.

The lifting transportation device may include a container access mechanism movable in a vertical direction with respect to the pair of second rails so as to take one or more containers stored in the storage sections and make the one or more containers available for the container carriage by placing the one or more containers to one or more storage cells in the second row of the storage sections.

The lifting transportation device and the container carriage may be configured for moving in different horizontal planes with respect to the ground so as to avoid interferences between them. In particular, while the first rails for the container carriage may be arranged below the first row of the storage sections. The second rails for the lifting transportation device may be arranged above the horizontal level corresponding to the second row of the storage sections.

In accordance with a method of the present disclosure, the following steps are performed for loading containers in a desired sequence onto boards of container carriages movable along parallel paths in the storage system having at least first, second and third storage sections:
selecting first, second and third containers held in the first, second and third storage sections, respectively, for loading onto a board of a selected container carriage,
positioning the board of the selected container carriage at a lower horizontal position to enable the selected container carriage to move under a respective line of the storage cells in the first row of the second storage section arranged between the first and third storage sections,
positioning the board of the selected container carriage at an upper horizontal position to enable the selected container carriage to take first, second and third selected containers of the desired sequence of containers from the second row of the first, second and third storage sections, respectively,
positioning the board of the selected container carriage at an intermediate horizontal position higher than the lower position but lower than the upper position, to enable the selected container carriage to place at least one of the first, second and third selected containers into the first row of at least one of the first, second and third storage sections, a transition between the upper position and the intermediate position being performed in a passage between adjacent storage sections, and
controlling the selected container carriage to place the first, second and third selected containers in the desired sequence on the board.

The board of the selected container carriage may be positioned at the intermediate horizontal position to enable the selected container to place at least one of the first, second and third selected containers into the first row of the second storage section.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 shows an exemplary embodiment of a storage system in accordance with the present disclosure.

FIGS. 2-5 illustrate an exemplary lifting transportation device of the present disclosure.

FIGS. 6-9 illustrate an example of operations performed by the lifting transportation device.

FIGS. 10-26 illustrate an example of loading a desired sequence of containers on a board of a container carriage.

### DETAILED DISCLOSURE OF THE EMBODIMENTS

The present disclosure will be made using examples of order fulfilment procedures. It will become apparent, however, that the concept of the disclosure is applicable to forming a desired sequence of containers in any retail or warehouse environment.

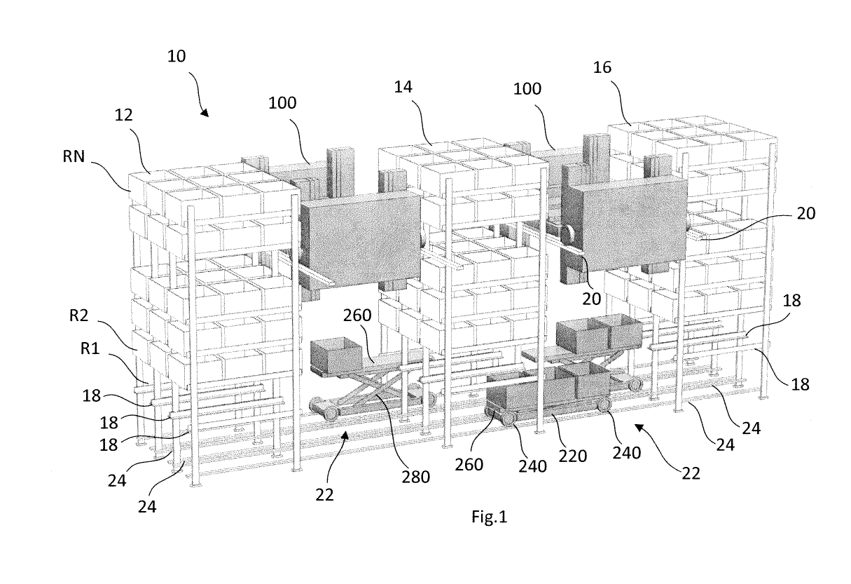

FIG. 1 illustrates an exemplary embodiment of a storage system 10 in accordance with the present disclosure. The storage system 10 may be arranged in a warehouse, order fulfillment center or retail facility. The storage system 10 may have multiple storage racks including storage racks 12, 14 and 16, each of which is configured for storing containers in storage cells arranged in multiple rows R1 to RN at various horizontal levels with respect to the ground. The containers may be any objects capable of holding goods stored in the storage area, such as cartons, boxes, crates, or pallets. The containers may be held in each row of the storage racks 12, 14 and 16 using holding elements 18 configured for holding containers. For example, as shown in FIG. 1, a pair of L-shaped holding elements 18 may be used to hold containers in each row of the respective storage rack.

Each row of the storage racks 12, 14 and 16 may contain multiple containers arranged in two mutually perpendicular horizontal directions. The storage racks 12, 14 and 16 may be arranged so as to provide passages between them. One or more lifting transportation devices 100 may be provided in each passage to handle containers stored in the storage racks 12, 14 and 16 from both sides of each passage. Although FIG. 1 shows three storage racks, the storage system 10 may include any number of storage racks arranged so as to provide passages between adjacent racks. For example, a storage system including multiple storage racks and multiple lifting transportation devices operating in passages between them is disclosed in my copending U.S. patent application Ser. No. 14/178,024, filed on Feb. 11, 2014, entitled “MULTI-LEVEL STORAGE SYSTEM WITH TRANSPORTATION DEVICES MOVABLE IN SUBSTANTIALLY PERPENDICULAR DIRECTIONS AND METHOD OF TRANSFERRING CONTAINERS IN DESIRED SEQUENCE,” and incorporated herewith by reference.

The lifting transportation device 100 is configured for moving in a horizontal direction along a pair of horizontal rails 20 arranged in the passage so as to have access to containers arranged in storage racks on both sides of the passage. As discussed in more detail below, the lifting transportation device 100 includes a frame movable along the pair of rails 20 and a movable platform configured to move up and down with respect to the frame so as to handle containers provided above and below the rails 20. In particular, a lifting transportation device may load a container from one selected row of the adjacent storage racks, and may unload that container to another selected row of the storage racks. The container may be unloaded to the same storage rack from which the container is taken. Alternatively, the container may be loaded from one storage rack and unloaded to the other storage rack.

Further, the system 10 includes container carriages 22 movable in a horizontal direction substantially perpendicular to the horizontal direction in which the lifting transportation device 100 moves. For example, the container carriages 22 may be used to move containers from the storage racks 12, 14 and 16 to an order picking station where orders are collected from multiple delivered containers.

The storage cells in each row of the storage sections 12, 14 and 16 are arranged in multiple parallel lines extending in the horizontal direction substantially perpendicular to the horizontal direction in which the lifting transportation device 100 moves. Multiple pairs of rails 24 for moving the container carriages 22 may be arranged in parallel corresponding to the respective lines of storage cells so as to provide access of each container carriage 22 to containers held in the respective line of the storage cells. The rails 24 may be arranged in the same horizontal plane, for example, on the ground of the storage system 10, in a direction substantially perpendicular to the direction of the rails 20. The rails 24 may be arranged below the lowest row R1 of the storage racks 12, 14 and 16.

FIG. 1 shows that each container carriage 22 is configured for moving along a pair of rails 24. However, the container carriage 22 may be configured to move along a single rail 24, or to move without rails along a path corresponding to the respective line of storage cell.

To avoid interferences between the container carriages 22 and the lifting transportation device 100, the pairs of rails 24 and the rails 20 are arranged on different horizontal planes with respect to the ground so as to provide movement of each container carriage 22 and the lifting transportation device 100 in different horizontal planes with respect to the ground.

The container carriage 22 may include a frame 220 with four wheels 240 fixed to the frame 220 which may be formed as a braced structure for supporting elements required to operate the container carriage 22. Each wheel 240 may be attached to the frame 220 so as to rotate in a vertical plane about an axis extending from the center of the wheel 240 in order to move the container carriage 22 along the rails 24.

The frame 220 may hold a board 260 that can be used for carrying containers. For example, the board 260 may be a rectangular metal plate configured to accommodate containers. A pantographic mechanism 280 may be provided on the frame 220 to raise the board 260 with respect to the frame 220 to a desired horizontal level, or to move the board 260 down to a lower position.

The level of the row R1 is selected so as to enable the container carriage 22 with containers on its board 260 to move below the row R1 when its board 260 is at a lower horizontal level with respect to the frame 220. For example, the container carriage 22 may be in a folded position with its board 260 lying on the frame 220.

As discussed in more detail later, the board 260 may be raised with respect to the frame 220 to a horizontal level corresponding to the level of a selected row in the storage racks 12, 14 and 16, so as to take one or more containers from the selected row or place one or more containers to the selected row. In particular, the board 260 may be positioned at an intermediate horizontal level with respect to the frame 220, higher that the lower horizontal level so as to take containers from the row R1 or to place containers to the row R1. Also, the board 260 may be positioned at an upper horizontal level with respect to the frame 220, higher than the intermediate horizontal level so as to place containers to the row R2 above the row R1, or to take containers from the row R2.

The storage system 10 of the present disclosure is configured so as to enable each container carriage 22 to load a desired sequence of containers on its board 260 without assistance of an external loading mechanism. In particular, as discussed below, the lifting transportation device 100 may place selected containers into storage cells arranged in the row R2 so as to make the selected containers accessible for the respective container carriage 22, which selectively places the containers in predetermined positions in rows R1 and R2 so as to load the selected containers on the board 260 in a desired sequence. The operations of each container carriage 22 may be controlled by a controller that may include a data processor responsive to external commands for processing the commands and producing various control signals.

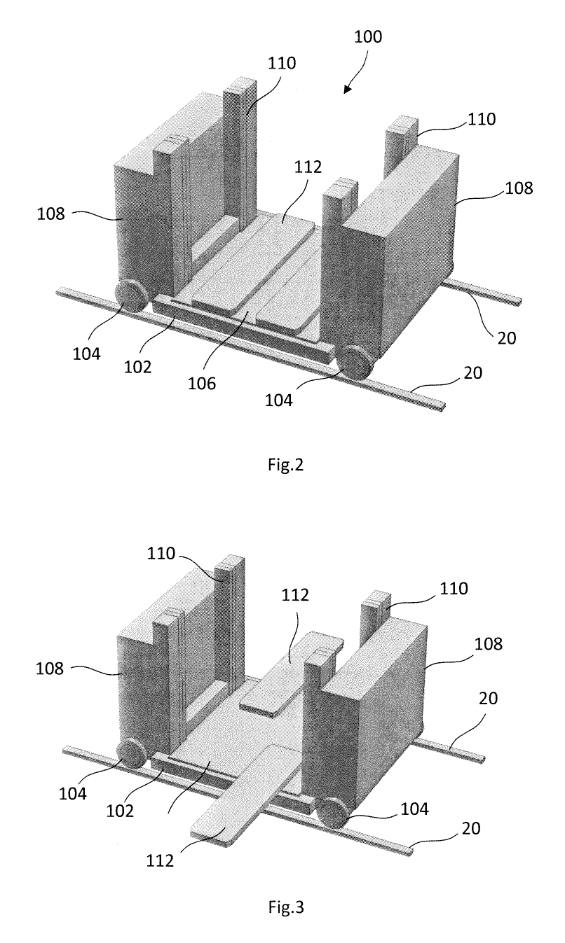

FIGS. 2-5 schematically illustrate an exemplary embodiment of the lifting transportation device 100 that may be used in the storage system 10. As shown in FIG. 2, a lifting transportation device 100 may include a frame 102 with four wheels 104 fixed to the frame 102 which may be formed as a braced structure for supporting elements required to operate the lifting transportation device 100. Each wheel 104 may be attached to the frame 102 so as to rotate in a vertical plane about an axis extending from the center of the wheel 104 in order to move the transportation device 100 along the rails 20.

The frame 102 may hold a movable platform 106 that can be used for carrying containers. For example, the platform 106 may be a rectangular metal plate configured to accommodate containers. Side walls 108 may be provided on the frame 102 to support loading and carrying containers.

The platform 106 may move in a vertical direction up and down with respect to the frame 102 so as to access containers arranged in rows above and below the level at which the rails 20 are arranged. A platform lifting mechanism 110 may be arranged at the side walls 108 to move the platform 106 in a vertical direction. The platform lifting mechanism 110 may be implemented using any well-known mechanisms for moving a plate up and down. For example, a telescopic mechanism can be utilized.

One or more handling elements 112 may be mounted on the platform 106 and configured for operating with containers. The handling elements 112 may take one or more containers from one row of the storage rack, place the container onto the transportation unit 100 for carrying to another row, and remove the container from the transportation device 100 for placing it at a selected row. The handling elements 112 may be extended in a horizontal direction from one or both sides of the transportation device 100 so as to handle containers arranged at one storage rack or both storage racks served by the transportation device 100. For example, the handling elements 112 may be implemented as a metal plate, spade, fork or pulling device.

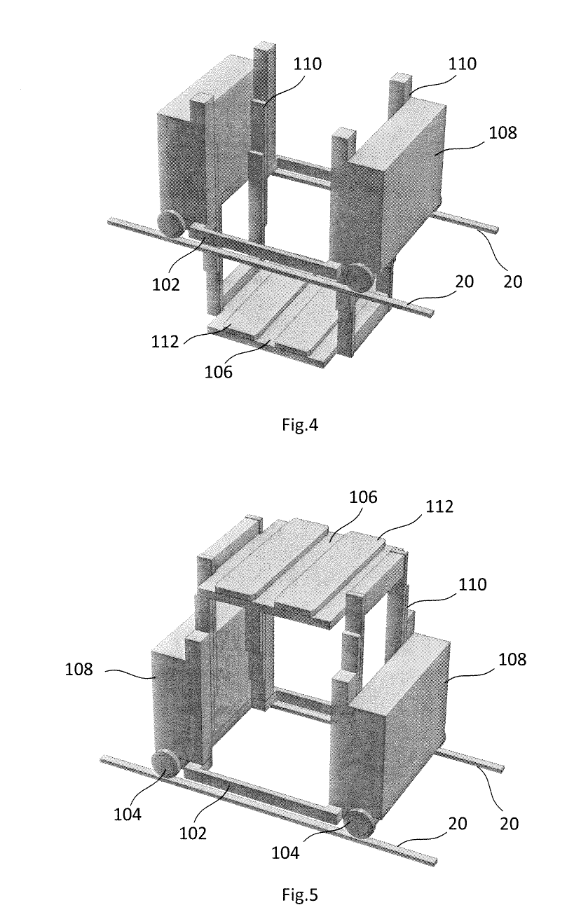

FIG. 3 illustrates the lifting transportation device 100 with the handling elements 112 extended from both sides of the lifting transportation device 100. FIG. 4 illustrates the lifting transportation device 100 with the movable platform 106 moved down with respect to the frame 102 so as to handle containers arranged in rows below the level of the corresponding rails 20. FIG. 5 illustrates the lifting transportation device 100 with the movable platform 106 raised with respect to the frame 102 so as to handle containers arranged in rows above the level of the corresponding rails 20.

The operations of the lifting transportation device 100 may be controlled by a controller that may include a data processor responsive to external commands for processing the commands and producing various control signals. The controller may communicate with various elements of the lifting transportation unit 100 to supply control signals to the elements of the transportation unit 100 and receive responses.

FIGS. 2-5 show a lifting transportation device 100 having the wheels 104 attached at the lower portion of the frame 102. However, the wheels 104 may be attached at the upper portion of the frame 102 or at the middle portion of the frame 102. Operations of an exemplary transportation device that can be used as the lifting transportation device 100 in the storage system 10 is described in more detail in my copending U.S. patent application Ser. No. 14/049,552 filed on Oct. 9, 2013 and entitled “AUTOMATIC ORDER PICKING SYSTEM AND METHOD IN RETAIL FACILITY,” and in my copending U.S. patent application Ser. No. 14/155,976 filed on Jan. 15, 2014 and entitled “TRANSFERRING CONTAINERS IN STORAGE SYSTEM,” both incorporated herewith by reference.

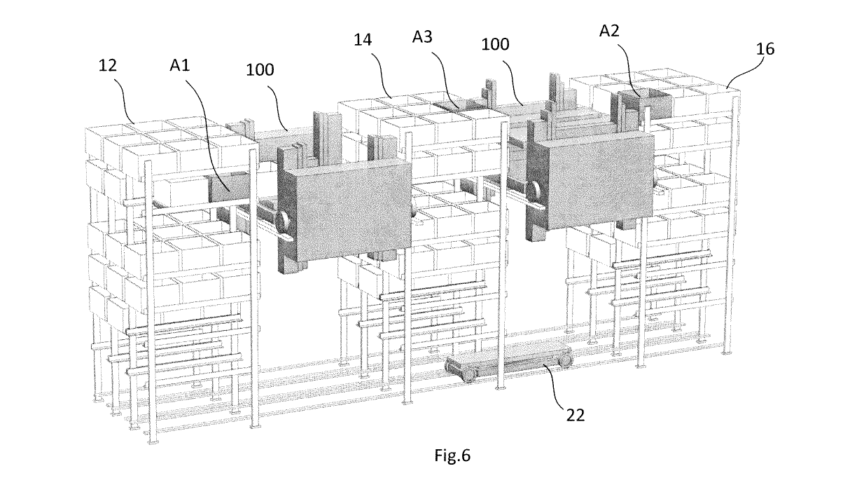

FIGS. 6-9 illustrate an example in which containers A1, A2 and A3 in a desired sequence are required to be loaded onto a selected container carriage 22 for preparing a particular order. As shown in FIG. 6, the selected containers A1, A2 and A3 may be stored in various rows of different storage racks. For example, container A1 may be stored in the storage rack 12, container A2 may be stored in the storage rack 16 and container A3 may be stored in the storage rack 14.

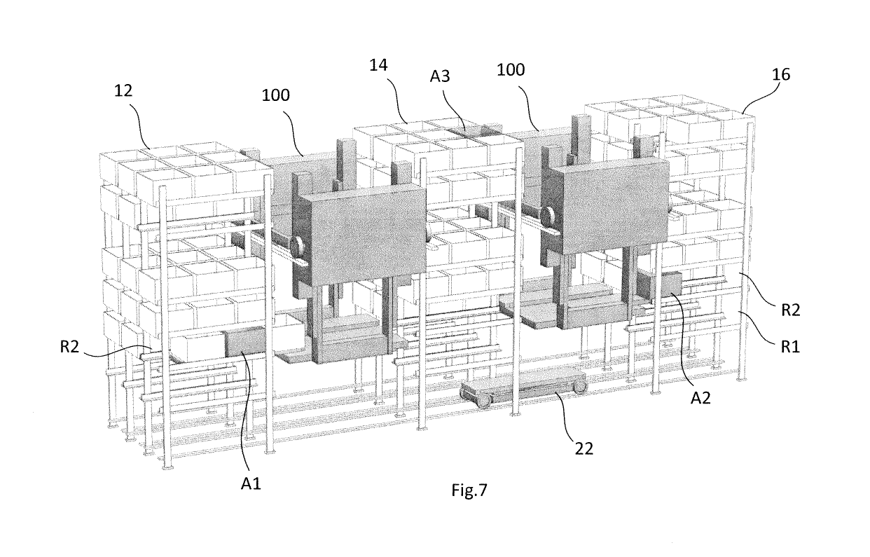

The lifting transportation device 100 operating in the passage between the storage racks 12 and 14 takes the container A1, together with the other containers in the rack 12 to be delivered to the order picking station, and places it into a storage cell in a selected line of the row R2 in the storage rack 12 (FIGS. 6 and 7). The selected line of storage cells is provided above a pair of rails 24 for moving the container carriage 22 selected for delivery of the containers A1, A2 and A3. At the same time, the lifting transportation device 100 operating in the passage between the storage racks 14 and 16 takes the container A2 stored in rack 16, and places it into a storage cell in the selected line of the row R2 in the storage rack 16.

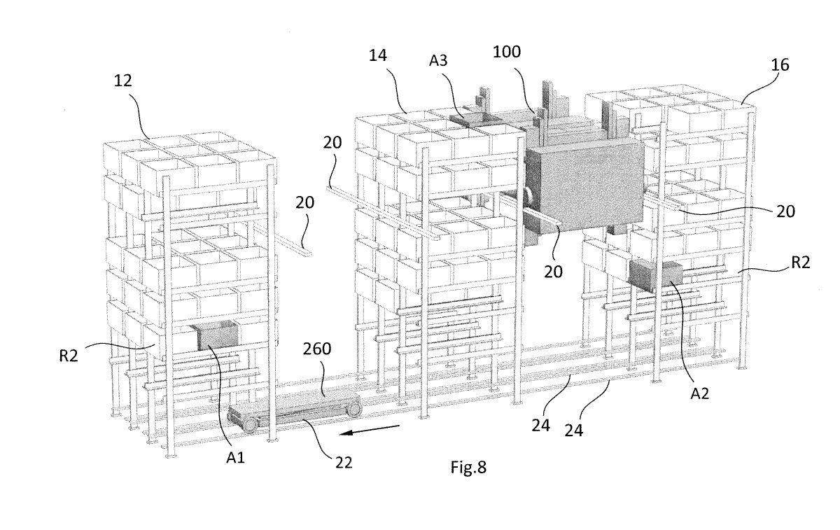

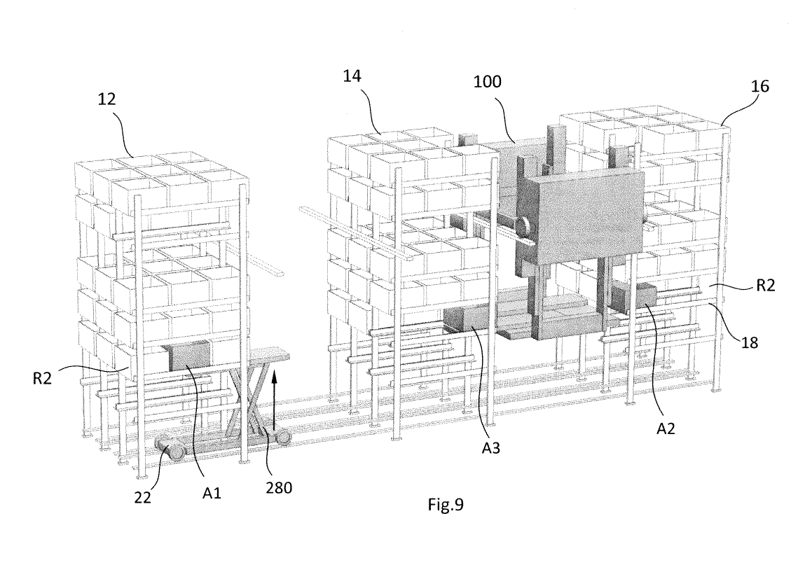

Then, the lifting transportation device 100 operating in the passage between the storage racks 14 and 16 takes the container A3 stored in the storage rack 14, and places it into a storage cell in the selected line of row R2 in the storage rack 14 (FIGS. 8 and 9). Hence, the lifting transportation devices 100 make the containers A1, A2 and A3 accessible for the container carriage 22 movable along the line of storage cells selected for holding containers A1, A2 and A3.

In accordance with an example illustrated in the present disclosure, the storage system 10 is configured to enable the selected container carriage 22 to load on its board 260, containers A1, A2 and A3 in a desired order. For example, the container carriage 22 may load the containers so as to place the container A1 at the edge of the board 260, place the container A2 on the board 260 next to the container A1, and place the container A3 on the board 260 next to the container A2. This order of containers may be selected to provide an order picking operator or an order picking device with a sequence of containers in which the container A1 is followed by the container A2, which is followed by the container A3. As a result, when the order picking operator or an order picking device forms a particular order involving items collected from the containers A1, A2 and A3, items of the order stored in the container A1 may be collected before the items stored in the container A2, and the items from the container A2 may be collected before the items from the container A3.

Referring to FIG. 8, when at least one of the selected containers A1, A2 and A3 is placed into the row R2, and the lifting transportation devices 100 continue their operations, the container carriage 22 may be moved along the rails 24 in the direction of the storage rack 12 in which container A1 is held. The board 260 of the container carriage 22 is positioned in a lower horizontal position, in which the board 260 lies on the frame 220 so as to allow the container carriage 220 to move below the row R1 of the storage rack 14.

As shown in FIG. 9, the container carriage 22 with the board 260 in the lower position may be moved along the rails 22 to a location under the storage cell at which container A1 is held. Thereafter, using the pantographic mechanism 280, the board 260 may be raised to its upper horizontal position slightly above the level of the holding elements 18 in the row R2, so as to place on the board 260, the container A1, together with a container stored in the same line between the passage at which a part of the container carriage 22 is located and the container A1. The width of the board 260 in a horizontal direction may be selected so as to be less than the distance between the holding elements 18 that hold containers in the storage racks.

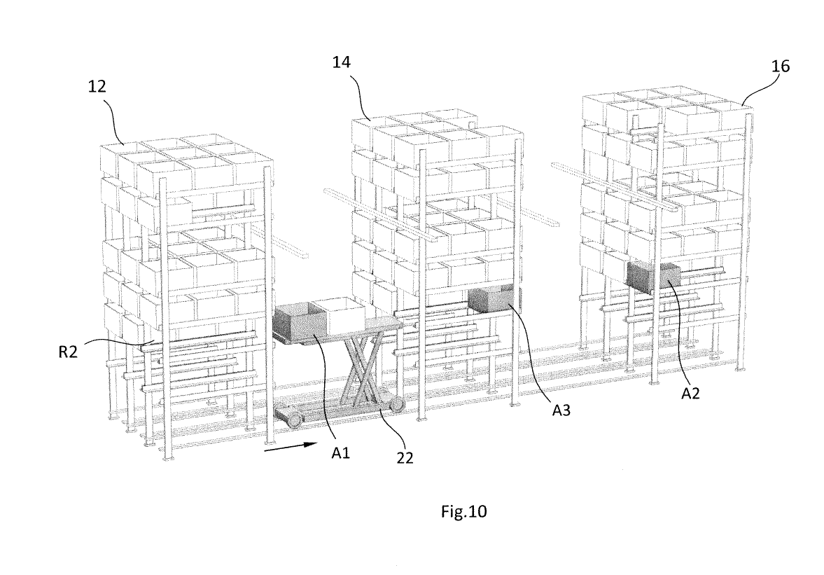

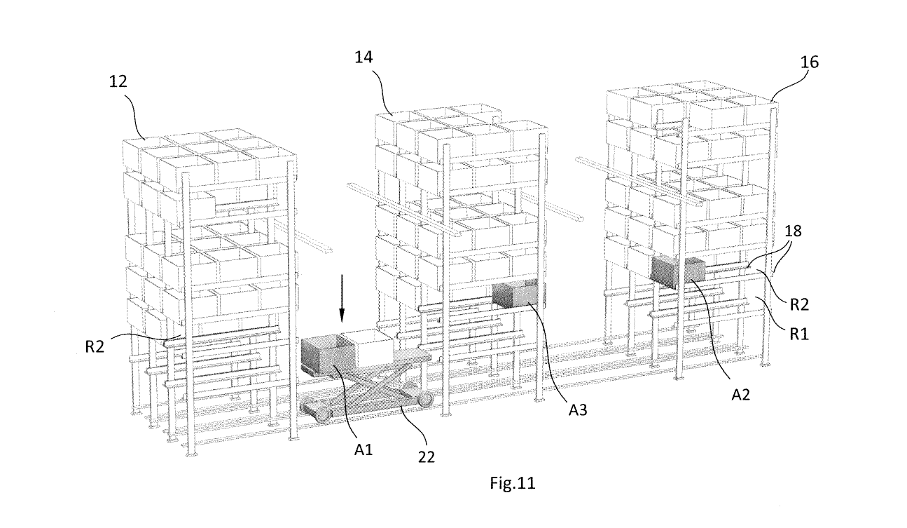

As shown in FIG. 10, when the containers are placed on the board 260, the container carriage 22 may be moved to a location in the passage between the storage racks 12 and 14. The board 260 carrying the containers is moved down to its intermediate horizontal position slightly above the level of the holding elements 18 for holding containers in row R1 (FIG. 11). In the intermediate horizontal position, the containers carried by the board are at the level above the holding elements 18 in the row R1 but below the holding elements 18 in the row R2

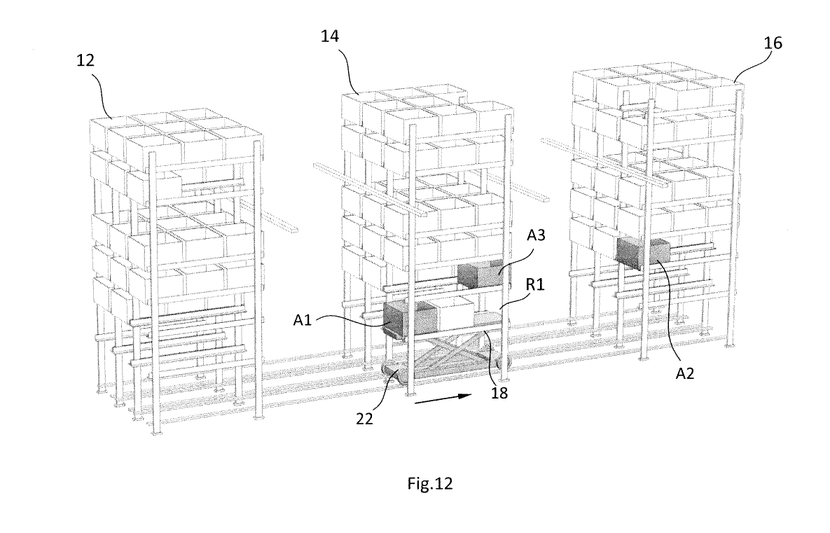

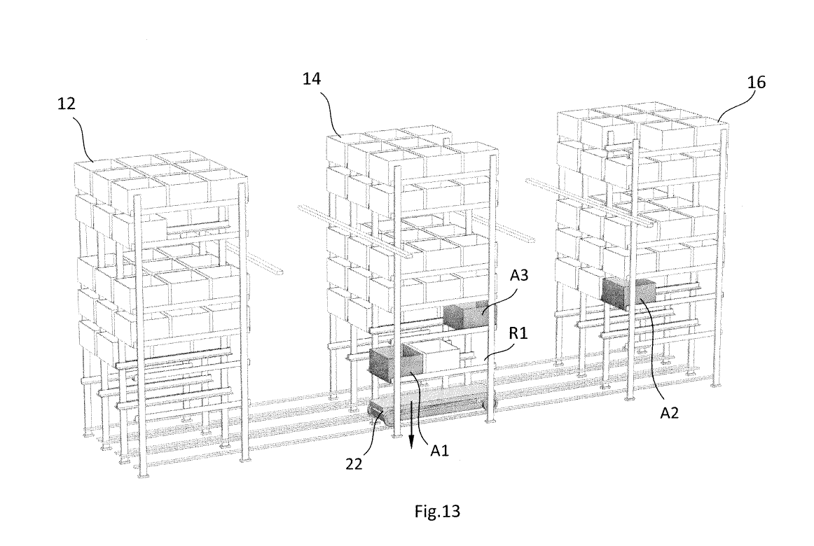

Referring to FIG. 12, the container carriage 22 may be moved in the direction of the storage rack 14 to unload the containers from the board 260 into the row R 1. When the container carriage 22 is placed into a selected position with respect to the rack 14, the board 260 is moved down to leave the unloaded containers on the holding elements 18 in the row R1 of the storage rack 14 (FIG. 13).

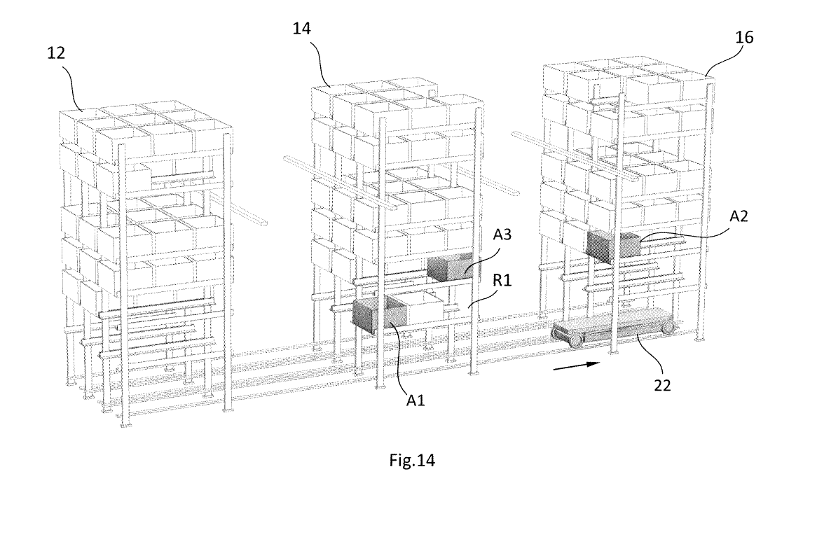

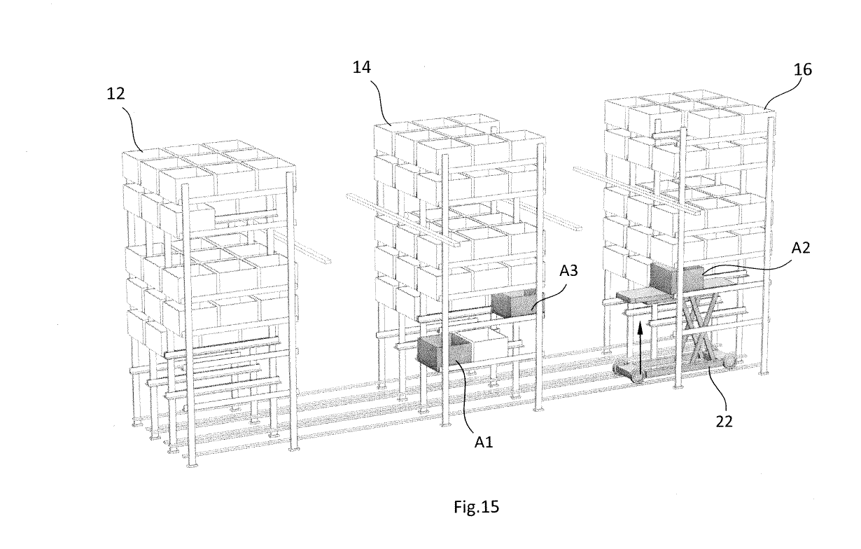

Thereafter, the container carriage 22 with the board in its lower position is moved in the direction of the storage rack 16 (FIG. 14), so as to place the board 260 below the container A2 held in the row R2 of the storage rack 16. The position of the container carriage 22 is selected so as to place the container A2 in a central portion of the board 260 leaving a space for the container A1 from one side of the container A2 and for the container A3 from the other side of the container A2 (FIG. 15). Thereafter, the board 260 is raised into the upper horizontal position slightly above the holding elements 18 in the row R2, so as to load the container A2 onto the board 260.

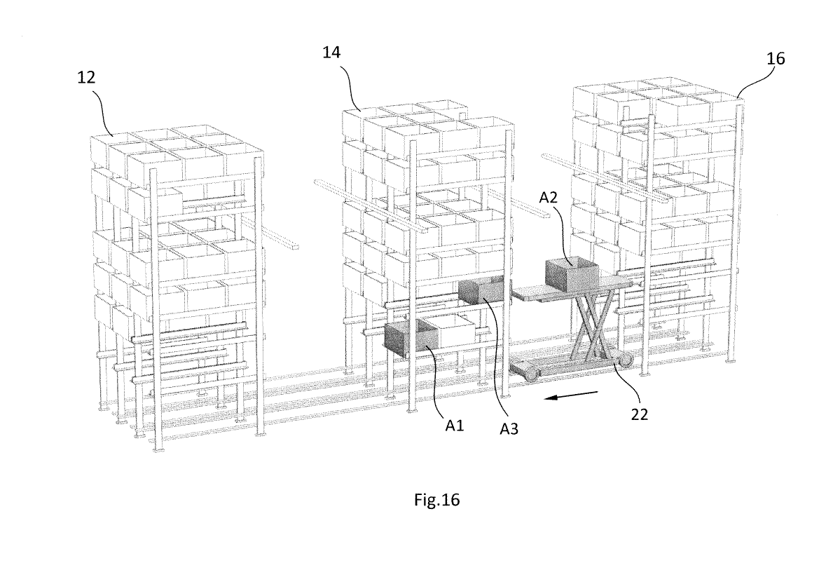

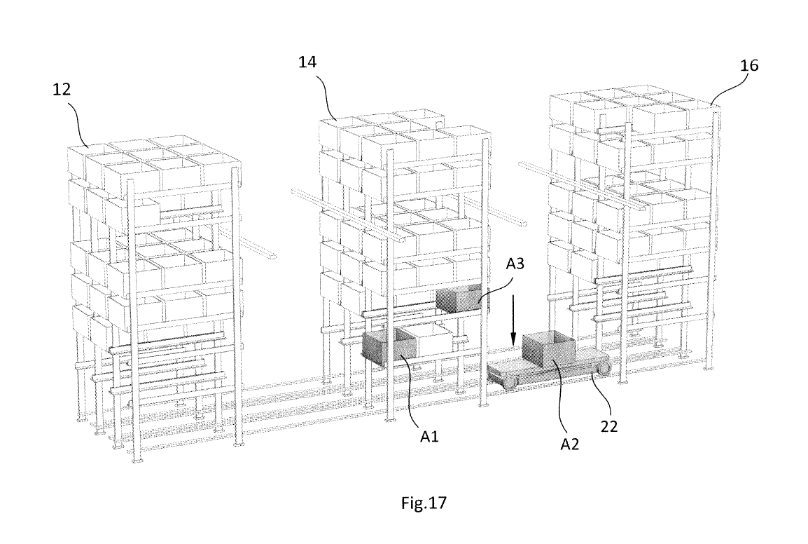

Referring to FIG. 16, the container carriage 22 with the container A2 is moved to the passage between the storage racks 14 and 16. Thereafter, the board 260 is moved down to its lower position (FIG. 17).

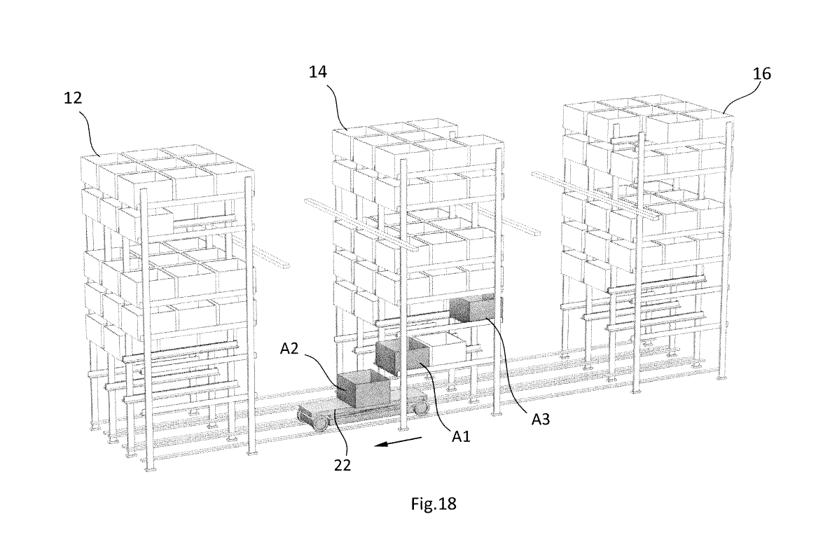

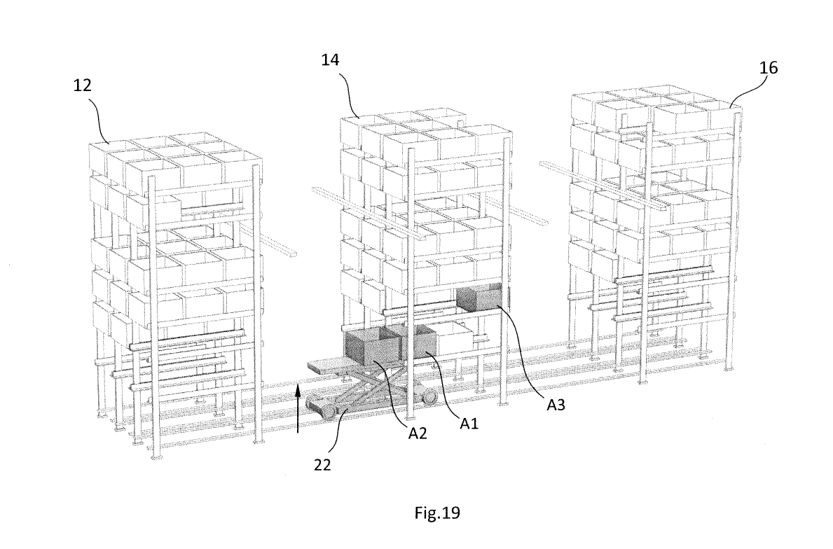

As shown in FIG. 18, the container carriage 22 with the container A2 on the board 260 placed in its lower position is moved under row R1 in the storage rack 14 until the container carriage 22 reaches a position under the container A1 selected so as to place the container A1 on the board 260 in a desired location next to the container A2. Thereafter, the board 260 is raised to its intermediate position to place the container A1 next to the container A2 (FIG. 19).

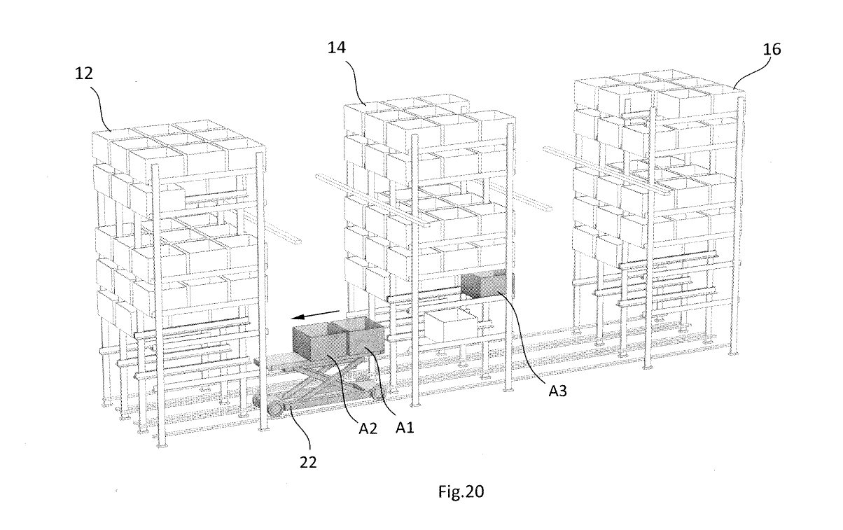

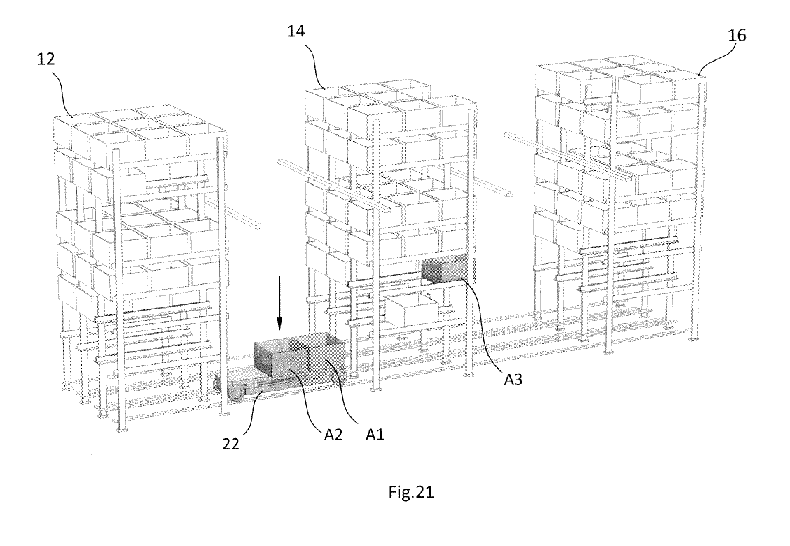

Referring to FIG. 20, the container carriage 22 with the containers A1 and A2 is moved to the passage between the storage racks 12 and 14. Then, the board 260 is moved down to its lower position (FIG. 21).

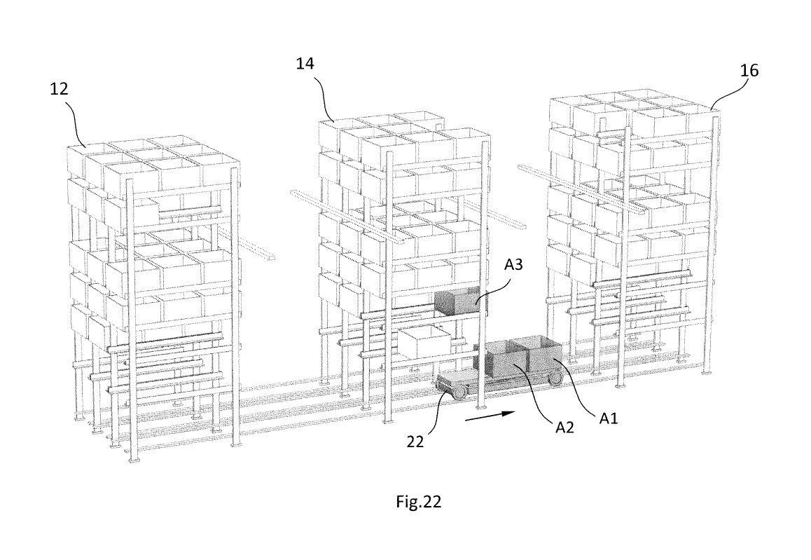

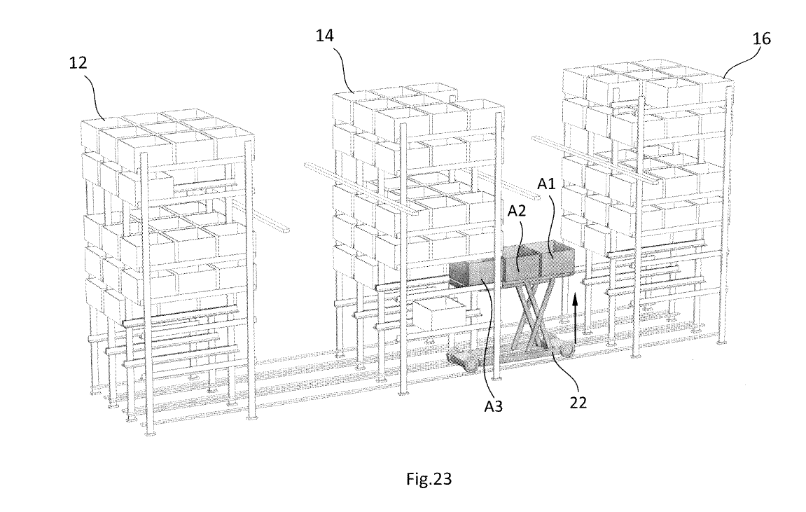

As shown in FIG. 22, with the board 260 in its lower position, the container carriage 22 carrying the containers A1 and A2 is moved below the row R1 in the storage rack 14 until the container carriage 22 reaches a position below the container A3 selected so as to place the container A3 on the board 260 next to the container A2. Thereafter, the board 260 is raised to its upper position slightly above the holding elements 18 in the row R2 to load the container A3 onto the board 260 next to the container A2 (FIG. 23).

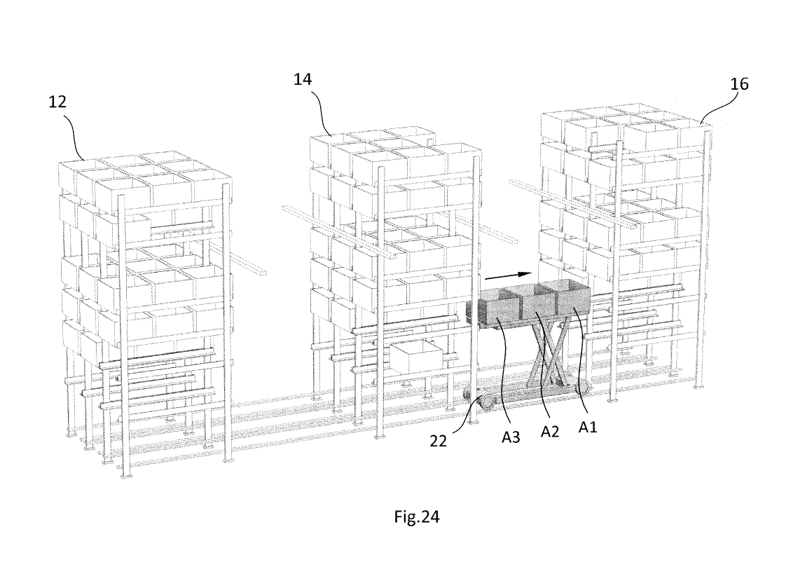

Referring to FIG. 24, the container carriage 22 with the containers A1, A2 and A3 is moved to the passage between the storage racks 14 and 16. Hence, the selected container carriage 22 is loaded with containers A1, A2 and A3 following in a desired order. The other container carriages 22 may be loaded in a similar manner.

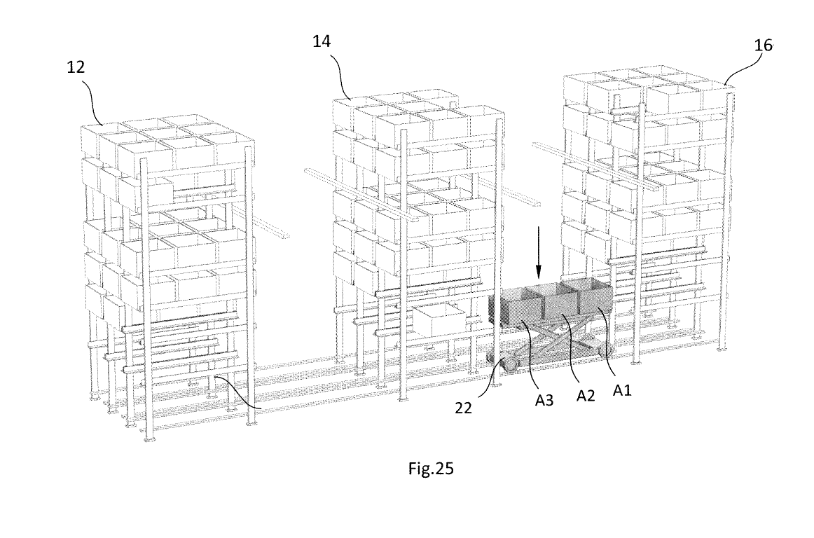

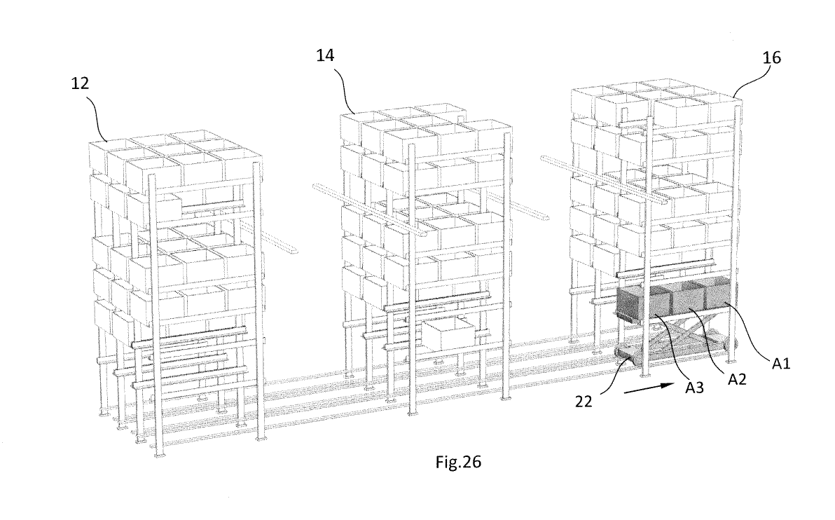

When the container carriage 22 is positioned in the passage, the board 260 may be moved down to its intermediate position (FIG. 25) so as to place a desired sequence of containers A1, A2 and A3 into row R1 of the storage rack 16 (FIG. 26). From the storage rack 16, the containers may be picked by a picker or a picking device in order to prepare an order.

Alternatively, the board 260 may be moved down to its lower position so as to move the container carriage 22 with the containers A1, A2 and A3 under the row R1 of the storage rack 16 to a desired destination. For example, the container carriage 22 with a desired sequence of containers A1, A2 and A3 may be moved to an order picking station. As one skilled in the art would realize, the loading operations described above present only one example of multiple possible scenarios that may be implemented for loading a desired sequence of containers A1, A2 and A3 onto the board 260 of the container carriage 22 using the storage system arrangement of the present disclosure.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein.

What is claimed is:

1. A storage system comprising:
multiple storage sections, each configured for storing containers in multiple storage cells arranged in multiple rows at various horizontal levels with respect to ground, the storage cells in each row being arranged in multiple parallel lines extending in a first horizontal direction, the storing sections being arranged so as to provide at least first and second passages between the storage sections; and
a plurality of container carriages configured for moving in the first horizontal direction along respective parallel paths corresponding to the lines of the storage cells,
a container carriage of the plurality of container carriages having a frame and a board for carrying containers, the container carriage being configured to position the board at first, second and third horizontal levels with respect to the frame,
the container carriage being further configured to move between the first and second passages under the storage cells arranged in a first row of the storage sections when the board is positioned at the first horizontal level,
the container carriage being further configured for loading containers onto the board in a desired sequence by taking a selected container from a storage cell in a second row of the storage section when the board is positioned at the third horizontal level, and placing the selected container to a storage sell in the first row when the board is positioned at the second horizontal level, a transition of the board between the second and third horizontal levels being provided when the container carriage is positioned in a passage between the storage sections.

2. The system of claim 1, wherein the container carriage is configured for taking containers loaded onto the board from storage sections separated by another storage section.

3. The system of claim 1, wherein the container carriage is configured to move along one or more first rails extending in the first horizontal direction.

4. The system of claim 1, further comprising at least one lifting transportation device provided in each of the first and second passages and configured for moving along a pair of second rails extending along a passage in a second horizontal direction substantially perpendicular to the first horizontal direction so as to have access to the storage cells arranged in the storage sections from both sides from the passage, the lifting transportation device including a container access mechanism movable in a vertical direction with respect to the pair of second rails so as to take one or more containers stored in the storage sections and make the one or more containers available for the container carriage by placing the one or more containers to one or more storage cells in the second row of the storage sections.

5. The system of claim 4, wherein the lifting transportation devices and the container carriages are configured for moving in different horizontal planes with respect to the ground so as to avoid interferences between the lifting transportation devices and the container carriages.

6. The system of claim 5, wherein the pair of second rails is arranged at a horizontal level above the horizontal level corresponding to the second row of the storage sections.

7. A method of loading containers in a desired sequence onto boards of container carriages movable along parallel paths in a first horizontal direction in a storage system having first, second and third storage sections configured for storing containers in multiple storage cells arranged in multiple rows including first and second rows at various horizontal levels with respect to ground, the storage cells in the first and second rows being arranged in multiple parallel lines extending in the first horizontal direction and corresponding to the paths of the container carriages, the storage sections being arranged so as to provide passages between adjacent storage sections, the method comprising:
selecting first, second and third containers held in the first, second and third storage sections, respectively, for loading onto a board of a selected container carriage,
positioning the board of the selected container carriage at a lower horizontal position to enable the selected container carriage to move under a respective line of the storage cells in the first row of the second storage section,
positioning the board of the selected container carriage at an upper horizontal position to enable the selected container carriage to take first, second and third selected containers of the desired sequence of containers from the second row of the first, second and third storage sections, respectively,
positioning the board of the selected container carriage at an intermediate horizontal position higher than the lower position but lower than the upper position, to enable the selected container carriage to place at least one of the first, second and third selected containers into the first row of at least one of the first, second and third storage sections, a transition between the upper position and the intermediate position being performed in a passage between the storage sections, and
controlling the selected container carriage to place the first, second and third selected containers in the desired sequence on the board.

8. The method of claim 7, wherein the board of the selected container carriage is positioned at the intermediate horizontal position to place at least one of the first, second and third selected containers into the first row of the second storage section arranged between the first storage section and the third storage section.

9. The method of claim 7, wherein the container carriages are configured to move in parallel along first rails extending in the first horizontal direction.

10. The method of claim 7, wherein the first, second and third selected containers are placed into the second row of the first, second and third storage sections by lifting transportation devices, each lifting transportation device being moved along a pair of second rails extending along a passage between the storage sections in a second horizontal direction substantially perpendicular to the first horizontal direction so as to access the storage cells arranged in the storage sections from both sides from the passage, the lifting transportation device includes a container access mechanism movable in a vertical direction with respect to the pair of second rails so as to take the first and second selected containers stored in the storage sections and place the first and second selected containers to the second row of the storage sections.

11. The method of claim 10, wherein the lifting transportation devices and the container carriages are moved in different horizontal planes with respect to the ground so as to avoid interferences between the lifting transportation device and the container carriages.

12. The method of claim 10, wherein the pair of second rails is arranged at a horizontal level above the horizontal level corresponding to the second row of the storage sections.
